(19) United States
(12) Patent Application Publication
(10) Pub. No.: US 2003/0227148 A1
(43) Pub. Date: Dec. 11, 2003

(54) Tool organization system

(76) Inventors: Sean Shipman, Fountain Valley, CA (US); Daryl Scherer, Westminster, CA (US)

Correspondence Address: LAW OFFICES OF ERIC KARICH, 2807 ST. MARK DR., MANSFIELD, TX, 76063, US

(21) Appl. No.: 10/167,780

(22) Filed: Jun. 10, 2002

(51) Int. Cl. B62B 11/00

(52) U.S. Cl. 280/47.34

(57) ABSTRACT

A tool organization system for organizing a plurality of tools has a mobile tool cart and a tool holder. The mobile tool cart includes a cart base, a base perimeter, and a cart sidewall extending upwardly from the base perimeter to an upper sidewall lip. The cart base and the cart sidewall cooperating to form a tool storage compartment. The tool holder is adapted to hold and organize the plurality of tools for easy reference and access while hanging on the mobile tool cart. The tool holder includes a flexible body and a support plate. The flexible body has a front surface and an opposing rear surface that terminate in a body perimeter having a top edge. A plurality of tool pockets are attached to the front surface of the flexible body for holding the plurality of tools. The support plate is attached adjacent the top edge of the flexible body and is adapted for hanging the flexible body on the mobile tool cart.

### CROSS-REFERENCE TO RELATED APPLICATIONS

Not Applicable

### STATEMENT REGARDING FEDERALLY SPONSORED RESEARCH

Not Applicable

### BACKGROUND OF THE INVENTION

1. Field of the Invention

This invention relates generally to tool organizers, and more particularly to a tool organization system that includes both a mobile tool cart and a tool organizer adapted to be removably attached to the mobile tool cart.

2. Description of the Related Art

The following art defines the present state of this field:

King, Jr., U.S. Pat. No. D257,090, teaches a tool holder constructed of a rigid material that includes an integral hook for hanging the tool holder from a worksurface.

Marinescu, U.S. Pat. No. 5,341,975, teaches a combination tool pouch and clip assembly. The tool pouch includes a clip that enables the user to hang the tool pouch on a belt.

Klimas, U.S. Pat. No. 5,547,080, teaches a tool box designed to be suspended from a ladder.

McGarrah, U.S. Pat. No. 5,924,615, teaches a storage box that includes a hangar that is adapted to hang the storage box from a truck bed. Similar storage boxes having different constructions are also taught in Basso et al., U.S. Pat. No. 5,785,222, and Johnson, U.S. Pat. No. 1,606,944.

The above-described references are hereby incorporated by reference in full.

The prior art teaches various storage devices for holding tools and other items, and the prior art also teaches the inclusion of a clip of hanging device for hanging the device from another surface such as a belt or a vehicle. However, the prior art does not teach a tool organization system that includes a tool organizer having the construction of the present invention. The prior art also does not teach the combination of the tool organizer with a mobile tool cart. The present invention fulfills these needs and provides further related advantages as described in the following summary.

### SUMMARY OF THE INVENTION

The present invention teaches certain benefits in construction and use which give rise to the objectives described below.

The present invention provides a tool organization system for organizing a plurality of tools. The tool organization system includes a mobile tool cart and a tool holder. The mobile tool cart includes a cart base having a base perimeter. A cart sidewall extends upwardly from the base perimeter to an upper sidewall lip. The cart base and the cart sidewall cooperating to form a tool storage compartment. The tool holder is adapted to hold and organize the plurality of tools for easy reference and access while hanging on the mobile tool cart. The tool holder includes a flexible body and a support plate. The flexible body has a front surface and an opposing rear surface that terminate in a body perimeter having a top edge. A plurality of tool pockets are attached to the front surface of the flexible body for holding the plurality of tools. The support plate is attached adjacent the top edge of the flexible body and is adapted for hanging the flexible body on the mobile tool cart.

A primary objective of the present invention is to provide a tool organization system having advantages not taught by the prior art.

Another objective is to provide a tool organization system that includes a tool organizer that is adapted to fit either on or inside a mobile tool cart.

A further objective is to provide a tool organization system that enables a user to easily transport a plurality of tools while maintaining the plurality of tools in an organized display that allows the plurality of tools to be easily located, used, and returned to their proper position.

Other features and advantages of the present invention will become apparent from the following more detailed description, taken in conjunction with the accompanying drawings, which illustrate, by way of example, the principles of the invention.

### BRIEF DESCRIPTION OF THE DRAWING

The accompanying drawings illustrate the present invention. In such drawings:

FIG. 1 is a perspective view of the preferred embodiment of the present invention;

FIG. 2 is a side elevational view thereof;

FIG. 3 is a plan view thereof; and

FIG. 4 is a sectional view thereof taken along line 4-4 in FIG. 2.

### DETAILED DESCRIPTION OF THE INVENTION

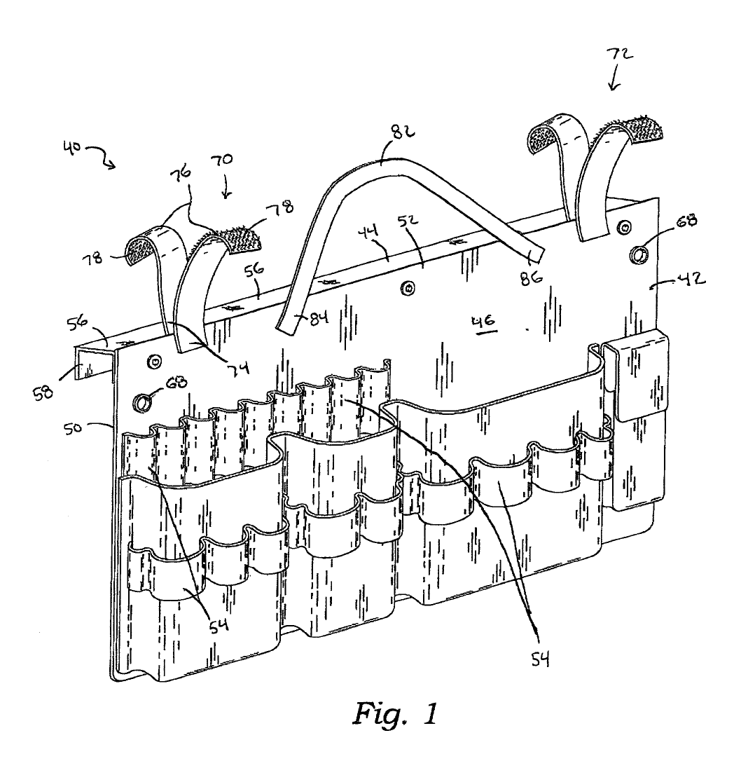

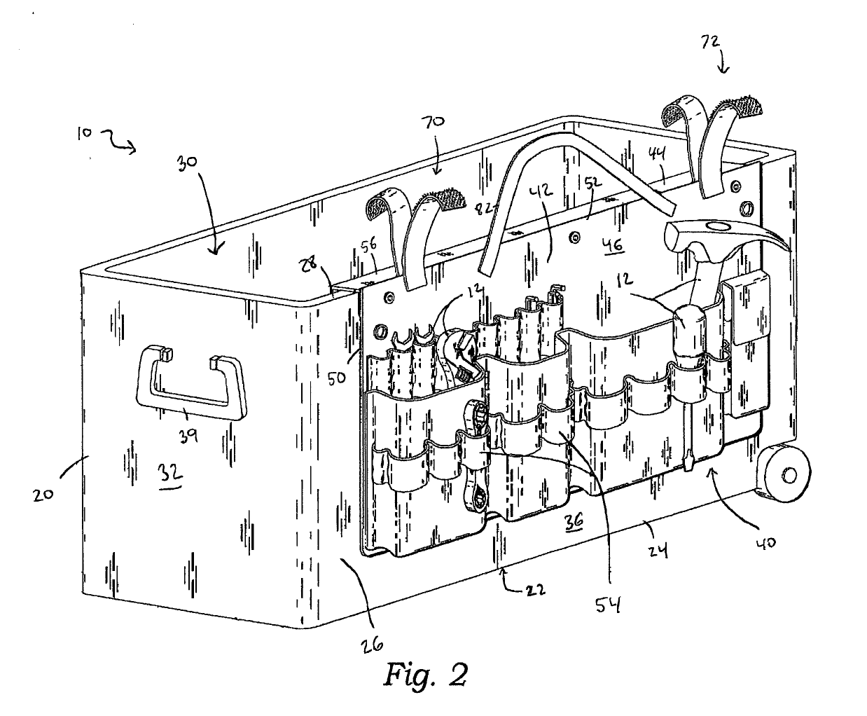

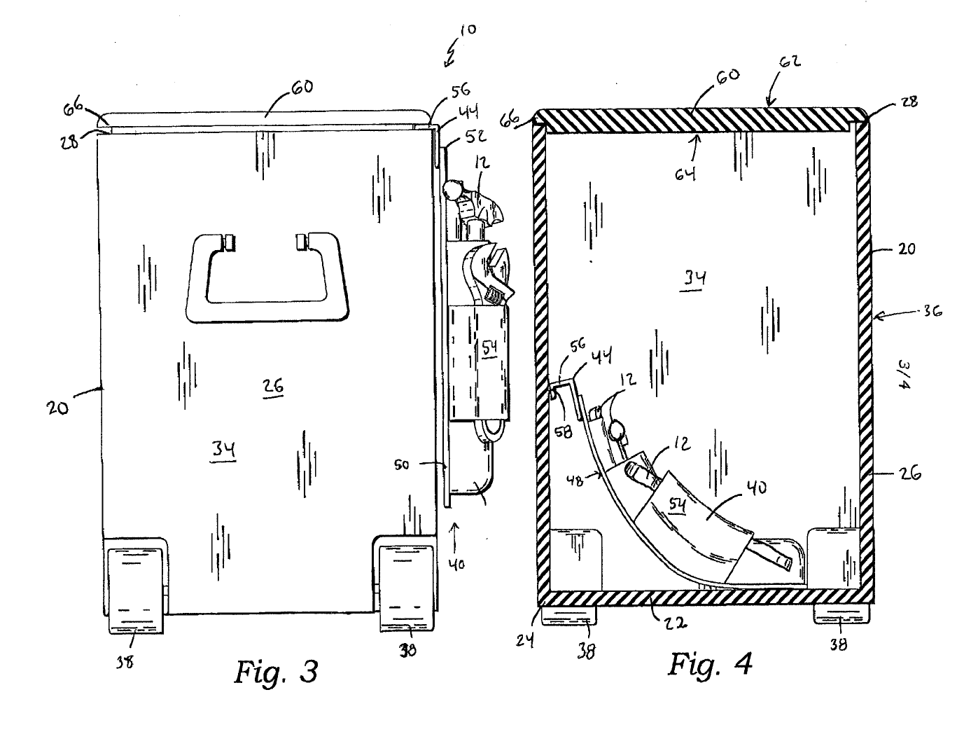

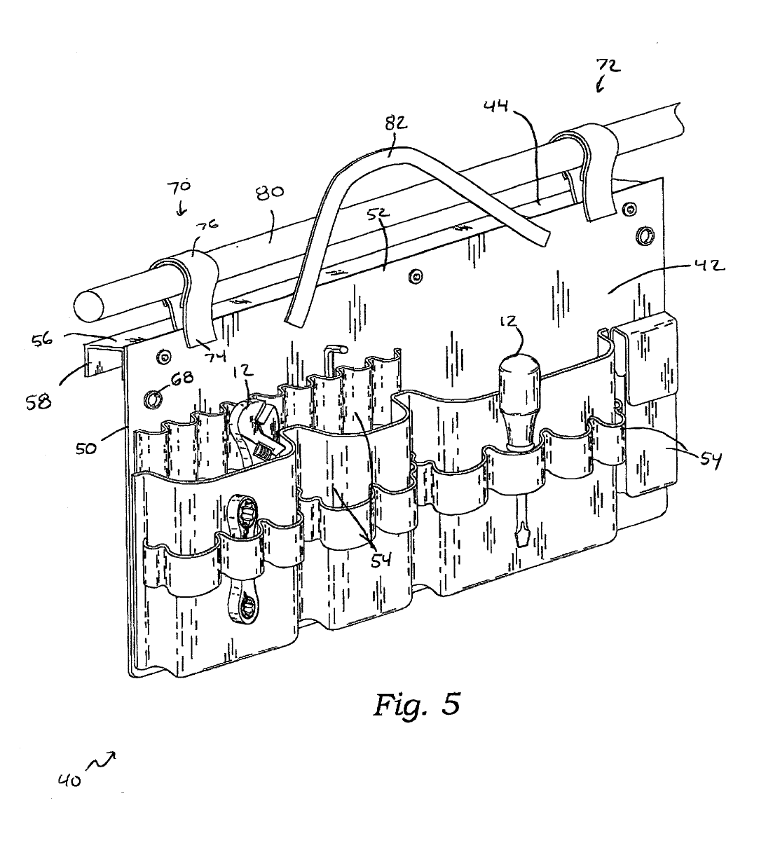

The above described drawing figures illustrate the invention, a tool organization system 10 for organizing a plurality of tools 12. As shown in FIGS. 1-5, the tool organization system 10 includes a mobile tool cart 20 and a tool holder 40. As shown in FIGS. 2-4, the mobile tool cart 20 is useful for storing and transporting the plurality of tools 12 and other equipment. As shown in FIGS. 1-5, the tool holder 40 is adapted to hold and organize the plurality of tools 12 for easy reference and access. The tool holder 40 is also adapted to hang on the mobile tool cart 20, as shown in FIGS. 2-3, or in the alternative, to be stored within the mobile tool cart 20, as shown in FIG. 4, and as described in greater detail below.

As shown in FIGS. 2-3, the mobile tool cart 20 includes a cart base 22 having a base perimeter 24. A cart sidewall 26 extends upwardly from the base perimeter 24 to an upper sidewall lip 28. The cart base 22 and the cart sidewall 26 cooperating to form a tool storage compartment 30. The mobile tool cart 20 is preferably generally rectangular in shape such that the cart sidewall 26 includes a forward panel 32 and a rearward panel 34 connected by a pair of opposing side panels 36. The mobile tool cart 20 is preferably constructed of plastic or similar strong yet lightweight material.

As shown in FIG. 3, the mobile tool cart 20 preferably includes a pair of wheels 38 rotatably attached adjacent the cart base 22 for at least partially supporting the cart base 22 for rolling movement of the mobile tool cart 20. While a single pair of wheels 38 is illustrated, it is understood that three or more wheels or equivalent elements could also be used, and should be considered within the scope of the claimed invention.

As shown in FIG. 2, the mobile tool cart 20 preferably further includes a cart handle 39 attached to the forward panel 32 opposite the pair of wheels 38 which are positioned generally under the rearward panel 34. The cart handle 39 is preferably pivotally attached to the forward panel 32 for pulling the mobile tool cart 20 on the pair of wheels 38.

The tool holder 40, shown in FIG. 1, is used in conjunction with the mobile tool cart 20 for organizing, carrying, storing, moving, displaying, and otherwise manipulating the plurality of tools 12. The tool holder 40 includes a flexible body 42 and a support plate 44. The flexible body 42 has a front surface 46 and an opposing rear surface 48 that together terminate in a body perimeter 50 having a top edge 52. A plurality of tool pockets 54 are attached to the front surface 46 of the flexible body 42 for holding the plurality of tools 12. The flexible body 42 is adapted for holding the plurality of tools 12, and is preferably constructed of canvas or similar strong yet flexible material.

The support plate 44 is attached adjacent the top edge 52 of the flexible body 42 and is adapted for hanging the flexible body 42 on the mobile tool cart 20. The support plate 44 has an outwardly extending portion 56 that terminates in a downwardly extending portion 58. The support plate 44, together with the outwardly extending portion 56 and the downwardly extending portion 58, are shaped to fit around the upper sidewall lip 28 of the mobile tool cart 20 for removably hanging the tool holder 40 on the mobile tool cart 20, as shown in FIG. 2.

The support plate 44 is preferably rigid, elongate, and shaped to fit along the entire top edge 52 of the tool holder 40. It is preferred that the support plate 44 is rigid because this enables the support plate 44 to provide lateral support to the flexible body 42, holding it in an open configuration and preventing it from collapsing in on itself. The rigid support plate 44 also provides a good handle for grasping, carrying, and hanging the tool holder 40, as described in greater detail below. In the preferred embodiment, the support plate 44 is constructed of steel, although similar materials such as aluminum, durable plastic, or the like, can also be used.

As shown in FIGS. 3-4, the mobile tool cart 20 preferably further includes a lid 60 having a top lid surface 62 and an opposing bottom lid surface 64 that terminate in a lid perimeter 66. The lid perimeter 66 is shaped to engage the upper sidewall lip 28. In the preferred embodiment, there is enough space between the lid perimeter 66 and the upper sidewall lip 28 so that the outwardly extending portion 56 and the downwardly extending portion 58 of the support plate 44 can fit therebetween, enabling the tool holder 40 to be hung from the mobile tool cart 20 without interfering with the placement of the lid 60.

As shown in FIG. 1, the tool holder 40 preferably includes a ring aperture 68 through the flexible body 42 of the tool holder 40, the ring aperture 68 being positioned adjacent the body perimeter 50. The ring aperture 68 is adapted for removably hanging the tool holder 40 from a hook (not shown). In an equivalent embodiment, not shown, the ring aperture 68 can also be an aperture through the support plate 44, and this should be considered within the scope of the claimed invention.

The tool holder 40 preferably further includes a first pair of hanging straps 70 and a second pair of hanging straps 72. Each of the hanging straps has a first end 74 attached to the tool holder 40 adjacent the top edge 52, and a second end 76. Each of the first and second pairs of hanging straps 70 and 72 is preferably a canvas strap that includes hooks and loops fasteners 78 for removably connecting the second ends 76 of each of the first and second pairs of hanging straps 70 and 72 to each other for removably attaching the tool holder 40 to a horizontal bar 80, as shown in FIG. 5. The first and second pairs of hanging straps 70 and 72 are preferably laterally spaced from each other by the rigid support plate 44. Equivalent strap arrangements can also be used, such as a pair of single straps (not shown) that include hooks and loops, snaps, or equivalent fasteners. The pair of single straps can be removably joined to themselves, or to the tool holder 40, or otherwise attached to removably hang the tool holder 40 on the horizontal bar 80. Such equivalents should be considered within the scope of the claimed invention.

Finally, as shown in FIG. 1, the tool holder 40 preferably further includes a handle strap 82 having a first handle end 84 and a second handle end 86. The first handle end 84 and the second handle end 86 are each attached to the tool holder 40 adjacent the top edge 52, and the first handle end 84 is laterally spaced from the second handle end 86 by the rigid support plate 44. The handle strap 82 is constructed of a strong and preferably flexible material such as canvas or similar material, although in some embodiments the handle strap 82 can be constructed of a rigid material such as plastic or steel.

The invention includes a method for storing a plurality of tools 12 in either a working configuration or a storage configuration using the tool organization system 10 described above. As shown in FIG. 1, the plurality of tools 12 are inserted into the plurality of tool pockets 54. While this element is described as pockets, this term specifically includes all manner or fasteners, holders, boxes, compartment, and the like that are suitable for holding, storing, and organizing tools and tool-related items. The tool holder 40 is then hung on the upper sidewall lip 28 of the mobile tool cart 20, as shown in FIG. 2, such that the plurality of tools 12 are positioned for easy access, in the working configuration. In this configuration, the outwardly extending portion 56 and the downwardly extending portion 58 are positioned over the upper sidewall lip 28 of the mobile tool cart 20.

When the plurality of tools 12 are no longer required, the tool holder 40 is removed from the mobile tool cart 20 and inserted into the tool storage compartment 30 such that the plurality of tools 12 are stored in the storage configuration, as shown in FIG. 4. In this configuration, the flexible body 42 can bend and fold as necessary to fit within the tool storage compartment 30. In this configuration, the lid 60 can be positioned on the mobile tool cart 20 such that the lid perimeter 66 engages the upper sidewall lip 28, thereby sealing the tool holder 40 within the tool storage compartment 30.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A tool organization system for organizing a plurality of tools, the tool organization system comprising:
a mobile tool cart having
a cart base having a base perimeter,
a cart sidewall extending upwardly from the base perimeter to an upper sidewall lip, the cart base and the cart sidewall cooperating to form a tool storage compartment, and
a pair of wheels rotatably attached adjacent the cart base for at least partially supporting the cart base for rolling movement; and
a tool holder having
a flexible body having a front surface and an opposing rear surface that terminate in a body perimeter having a top edge,
a plurality of tool pockets attached to the front surface of the flexible body, and
a support plate attached adjacent the top edge, the support plate having an outwardly extending portion that terminates in a downwardly extending portion, the support plate, the outwardly extending portion, and the downwardly extending portion being shaped to fit around the upper sidewall lip of the mobile tool cart.

2. The tool organization system of claim 1 further comprising a lid having a top lid surface and an opposing bottom lid surface that terminate in a lid perimeter, the lid perimeter being shaped to engage the upper sidewall lip.

3. The tool organization system of claim 1 wherein the cart sidewall includes a forward panel and a rearward panel connected by a pair of opposing side panels.

4. The tool organization system of claim 3 further comprising a cart handle attached to the forward panel opposite the pair of wheels which are positioned generally under the rearward panel.

5. The tool organization system of claim 4 wherein the cart handle is pivotally attached to the forward panel.

6. The tool organization system of claim 1 wherein the support plate is rigid, elongate, and shaped to fit along the entire top edge of the tool holder.

7. A tool holder adapted to be either removably attached to an upper sidewall lip of a mobile tool cart, or stored within a tool storage compartment of the mobile tool cart, the tool holder comprising:
a flexible body having a front surface and an opposing rear surface that terminate in a body perimeter having a top edge;
a plurality of tool pockets attached to the front surface of the flexible body; and
a rigid support plate attached adjacent the top edge, the rigid support plate having an outwardly extending portion that extends to a downwardly extending portion,
the rigid support plate, the outwardly extending portion, and the downwardly extending portion being adapted to fit around the upper sidewall lip of the mobile tool cart for removably handing the tool holder on the mobile tool cart, and
the flexible body and the rigid support plate being shaped and sized to fit within the tool storage compartment of the mobile tool cart.

8. The tool holder of claim 7 wherein the rigid support plate is elongate and shaped to fit along the entire top edge of the tool holder.

9. The tool holder of claim 7 further comprising a ring aperture through the flexible body of the tool holder, the ring aperture being positioned adjacent the body perimeter.

10. The tool holder of claim 7 further comprising a first pair of hanging straps and a second pair of hanging straps, each of the hanging straps having a first end attached to the tool holder adjacent the top edge, and a second end, each of the first and second pairs of hanging straps having hooks and loops fasteners for removably connecting the second ends of each of the first and second pairs of hanging straps to each other for removably attaching the tool holder to a horizontal bar.

11. The tool holder of claim 10 wherein the first and second pairs of hanging straps are laterally spaced from each other by the rigid support plate.

12. The tool holder of claim 7 further comprising a handle strap having a first handle end and a second handle end, the first handle end and the second handle end each being attached to the tool holder adjacent the top edge, the first handle end being laterally spaced from the second handle end by the rigid support plate.

13. A method for storing a plurality of tools in either a working configuration or a storage configuration, the method comprising the steps of:
providing a mobile tool cart having a cart base having a base perimeter, a cart sidewall extending upwardly from the base perimeter to an upper sidewall lip, the cart base and the cart sidewall cooperating to form a tool storage compartment, and a pair of wheels rotatably attached adjacent the cart base for at least partially supporting the cart base for rolling movement;
providing a tool holder having a flexible body having a front surface and an opposing rear surface that terminate in a body perimeter having a top edge, a plurality of tool pockets attached to the front surface of the flexible body, and a support plate attached adjacent the top edge, the support plate having a means for removably hanging the tool holder from the upper sidewall lip of the mobile tool cart;
inserting the plurality of tools into the plurality of tool pockets;
hanging the tool holder on the upper sidewall lip of the mobile tool cart such that the plurality of tools are positioned for easy access, in the working configuration;
removing the tool holder from the upper sidewall lip of the mobile tool cart; and
inserting the tool holder into the tool storage compartment such that the tool are stored in the storage configuration.

14. The method of claim 13 further comprising the steps of:
providing a lid having a top lid surface and an opposing bottom lid surface that terminate in a lid perimeter; and
positioning the lid on the mobile tool cart such that the lid perimeter engages the upper sidewall lip, thereby sealing the tool holder within the tool storage compartment.

15. The method of claim 13 wherein the support plate is rigid, elongate, and shaped to fit along the entire top edge of the tool holder.

16. The method of claim 15 wherein the rigid support plate is elongate and shaped to fit along the entire top edge of the tool holder.

17. The method of claim 13 wherein the tool holder further includes a ring aperture through the flexible body adjacent the body perimeter.

18. The method of claim 13 wherein the tool holder further includes a first pair of hanging straps and a second pair of hanging straps, each of the hanging straps having a first end attached to the tool holder adjacent the top edge, and a second end, each of the first and second pairs of hanging straps having hooks and loops fasteners for removably connecting the second ends of each of the first and second pairs of hanging straps to each other for removably attaching the tool holder to a horizontal bar.

19. The method of claim 18 wherein the first and second pairs of hanging straps are laterally spaced from each other by the rigid support plate.

20. The method of claim 13 wherein the tool holder further includes a handle strap having a first handle end and a second handle end, the first handle end and the second handle end each being attached to the tool holder adjacent the top edge, the first handle end being laterally spaced from the second handle end by the rigid support plate.
